(19) United States
(12) Patent Application Publication
(10) Pub. No.: US 2018/0370379 A1
(43) Pub. Date: Dec. 27, 2018

(54) SYSTEMS AND METHODS FOR INTEGRATED VEHICLE CHARGING AND CONTENT DELIVERY

(71) Applicant: Faraday&Future Inc., Gardena, CA (US)

(72) Inventors: Pei Chen, Alhambra, CA (US); Zion Maffeo, Sunnyvale, CA (US); Michael Hong, Irvine, CA (US); Kenneth X. Xie, Manhattan Beach, CA (US)

(21) Appl. No.: 15/775,003

(22) PCT Filed: Dec. 20, 2016
(86) PCT No.: PCT/US2016/067712

§ 371 Date: May 9, 2018

Related U.S. Application Data
(60) Provisional application No. 62/270,443, filed on Dec. 21, 2015.

(51) Int. Cl. B60L 11/18; G06Q 30/02

(52) U.S. Cl. CPC B60L 11/1848; B60L 11/1861; B60L 2250/20; G06Q 30/0226; B60L 2250/16; B60L 11/1846

(57) ABSTRACT

A vehicle charging method includes receiving data corresponding to a battery status parameter of at least one battery associated with a vehicle that is at least partially electrically powered and determining a charging parameter for the at least one battery based on the data. The vehicle charging method also includes determining content to be delivered to a user based on the determined charging parameter and delivering the content to the user via a content delivery system while charging the battery according to the charging parameter.

### CROSS-REFERENCE TO RELATED APPLICATIONS

This application claims the benefit of U.S. Provisional Application No. 62/270,443, filed on Dec. 21, 2015. The subject matter of the aforementioned application is incorporated herein by reference.

### TECHNICAL FIELD

The present disclosure relates generally to a system and method for vehicle charging and, more particularly, to a system and method for integration of vehicle charging and content delivery.

### BACKGROUND

Electric vehicles powered partially or fully by electricity have become increasingly prevalent due to their reduced environmental footprint and their capability of implementing advanced control and entertainment features as compared to their gas powered counterparts. Such electric vehicles typically require recharging of internal energy storage devices, such as batteries, through a charging station that supplies electric energy to the electric vehicle. However, the monetary cost for providing the electric energy to the vehicle is typically calculated via an inflexible formula based on either the charging time or the total charging energy provided. For example, the cost may be determined by multiplying the total charging time by the cost per unit of time or by multiplying the total energy used to charge by the cost per unit of energy. Based on either formula, the cost per unit of time or energy is typically fixed by the charge station provider and non-negotiable, thus limiting the availability of saving or incentive mechanisms.

Additionally, the transfer of electricity from the charge station to the electric vehicle may present an inconvenience for a user of the electric vehicle who must wait for the electric vehicle to recharge.

The disclosed systems and methods are directed to addressing one or more of the problems set forth above.

### SUMMARY

In one aspect, the present disclosure is directed to a vehicle charging method including receiving data corresponding to a battery status parameter of at least one battery associated with a vehicle that is at least partially electrically powered vehicle and determining a charging parameter for the at least one battery based on the data. The method also includes determining content to be delivered to a user based on the determined charging parameter and delivering the content to the user via a content delivery system while charging the battery according to the charging parameter.

In another aspect, the present disclosure is directed to a vehicle charging method including displaying categorized content to a user via a user interface of a content delivery system and receiving data corresponding to user-selected content from the categorized content. The method also includes determining at least one content parameter associated with the user-selected content and determining one or more charging parameters for charging at least one battery associated with a vehicle that is at least partially electrically powered based on the at least one content parameter. The method further includes delivering the user-selected content to the user via the content delivery system while charging the battery according to the charging parameter.

In another aspect, the present disclosure is directed to a vehicle charging method including receiving data corresponding to a user selection of content to be delivered to a vehicle that is at least partially electrically powered and determining at least one content parameter associated with the user-selected content. The vehicle charging method also includes determining a charging parameter for charging at least one battery of the vehicle based on the at least one content parameter and determining a cost for charging the at least one battery or providing the user-selected content, based on at least one of the user-selected content, the charging parameter, and the at least one content parameter.

In another aspect, the present disclosure is directed to a vehicle charging method including displaying categorized content including sponsored content to a user via a user interface of a content delivery system, receiving data corresponding to a user selection of sponsored content, and determining a discounted cost for providing a charging power to at least one battery of a vehicle that is at least partially electrically powered, based on the user selection of the sponsored content.

In another aspect, the present disclosure is directed to a method for managing a vehicle user account using a cloud database. The method includes associating a digital content account of a user with a vehicle that is at least partially electrically powered, receiving an indication that charging power is provided to the vehicle, and storing digital content consumed by the user to the cloud database. The method further includes storing credits earned by the user associated with the digital content account to the cloud database and providing the credits to offset a cost of providing the charging power.

### BRIEF DESCRIPTION OF THE DRAWINGS

FIG. 1 is a block diagram of an exemplary vehicle charging system, according to an aspect of the disclosure;

FIG. 2 is a flowchart illustrating an exemplary process for determining a charging parameter based on a battery status parameter, according to an aspect of the disclosure;

FIG. 3 is a flowchart illustrating an exemplary process for determining a charging parameter based on a content parameter, according to an aspect of the disclosure;

FIG. 4 is a flowchart illustrating an exemplary process for determining a monetary cost for battery charging, according to an aspect of the disclosure;

FIG. 5 is a flowchart illustrating an exemplary process for providing discounted battery charging based on consumption of sponsored content, according to an aspect of the disclosure; and

FIG. 6 is a flowchart illustrating an exemplary process for storing vehicle and/or user data to a cloud database, according to an aspect of the disclosure.

### DETAILED DESCRIPTION

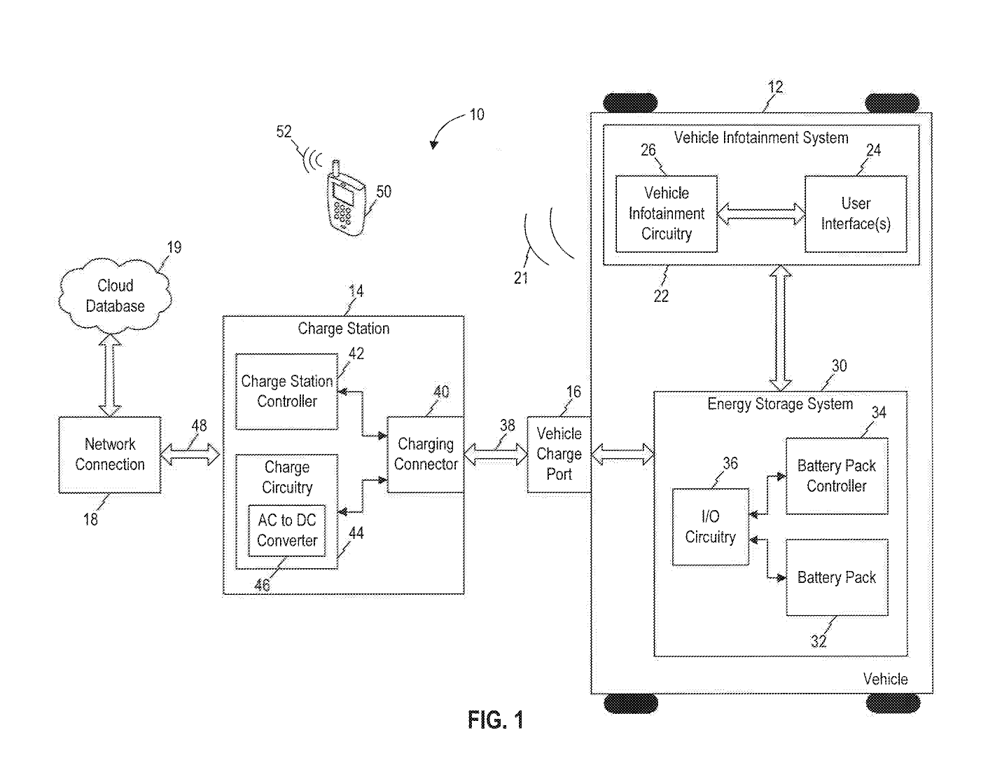

FIG. 1 is a block diagram illustrating an exemplary vehicle charging system 10 for charging an exemplary vehicle 12, according to an aspect of the present disclosure. Vehicle 12 may have any body style, such as a sports car, a coupe, a sedan, a pick-up truck, a station wagon, a sports utility vehicle (SUV), a minivan, or a conversion van. Vehicle 12 may be an electric vehicle, a hybrid vehicle, or any other vehicle that is completely or partially powered by electricity.

As illustrated in FIG. 1, charging system 10 may include one or more charging components of vehicle 12, a charge station 14, and a vehicle charge port 16 configured to couple vehicle 12 to charge station 14. Charge station 14 may be further in communication with local or remote servers through a network connection 18 to gain access to cloud database 19, which may be stored in a cloud database 19. During operation, charge station 14 may deliver power to vehicle 12 via vehicle charge port 16. Consistent with some embodiments, vehicle 12 and charge station 14 may also exchange data through vehicle charge port 16. Vehicle charge port 16 may be located, for example, at a vehicle charging location, such as a grocery store or other electrical power fueling station.

Vehicle 12 may include a vehicle infotainment system 22 configured to receive inputs from a user and to deliver entertainment, such as user selected content, to the user. Consistent with the disclosure, a user may be any occupant of vehicle 12, including the driver and passengers, or any other individual capable of interfacing with one or more components of vehicle 12 either remotely or locally. To that end, vehicle infotainment system 22 may include one or more user interfaces 24. User interface(s) 24 may be located in any suitable location within vehicle 12. For example, user interface(s) 24 may be embedded or mounted onto a vehicle dashboard and/or installed in a center console, a steering wheel, and/or a smart phone. User interface(s) 24 may be configured to receive data input, such as the selection of content, from users who are occupants of vehicle 12, and send the data to vehicle infotainment circuitry 26 for processing.

User interface(s) 24 may include an LCD, an LED, a plasma display, or any other suitable type of display. In some embodiments, user interface(s) 24 may provide a Graphical User interface (GUI) presented on the display for user input and data display. User interface(s) 24 may further include a touchscreen, a touch pad, a keyboard, a mouse, or a tracker ball to enable user input. User interface(s) 24 may also be configured to receive inputs via voice commands and/or gesture commands.

Furthermore, in one embodiment, user interface(s) 24 may present content entertainment options to the user, such as a selection between various types of content. The rich content available to the user via the user interface(s) may include, but is not limited to, movies, video games, television shows, audio programs, or other digital content available locally or on the Internet, etc. The content may be displayed on user interface(s) in any suitable manner. For example, the content may be categorized such that content having a given feature (e.g., same running time, genre, actors, etc.) is grouped and displayed together. In another embodiment, updates to vehicle 12 and/or data logs associated with vehicle 12 may be communicated to the user via user interface(s) 24.

User interface(s) 24 may be communicatively coupled to vehicle infotainment circuitry 26. Vehicle infotainment circuitry 26 may include any suitable circuitry configured to process data being delivered to and/or received from user interface(s) 24. For example, in some embodiments, vehicle infotainment circuitry 26 may include processing circuitry (not shown) having any appropriate type, such as general-purpose or special-purpose microprocessor, digital signal processor, or microcontroller. Vehicle infotainment circuitry 26 may further include one or more storage devices (not shown), for example, in the form of any appropriate type of mass storage for storing information. For example, the storage device may include one or more hard disk devices, optical disk devices, or other storage devices to provide storage space. Vehicle infotainment circuitry 26 may also include one or more memory devices (not shown) including, but not limited to, a read only memory (ROM), a flash memory, a dynamic random access memory (RAM), and a static RAM.

Vehicle 12 may also include an energy storage system 30 configured to store electrical power and partially or fully power vehicle 12 with electricity. Energy storage system 30 may include a battery pack 32, a battery pack controller 34, and input/output (I/O) circuitry 36. Battery pack 32 may include one or more batteries configured to selectively charge to store power for later use and to selectively discharge to provide electricity to power vehicle 12. However, in other embodiments, battery pack 32 may be replaced with any other energy storage devices capable of selectively storing and releasing power.

Battery pack controller 34 may be configured to communicate within energy storage system 30 to bidirectionally exchange data with charge station 14 via I/O circuitry 36. Further, battery pack controller 34 may be configured to bidirectionally exchange data with vehicle infotainment circuitry 26. As such, battery pack controller 34 may facilitate the exchange of data between vehicle infotainment system 22 and one or more systems or devices external to vehicle 12, such as charge station 14.

Battery pack controller 34 may include any suitable circuitry configured to process data being delivered to and/or received from energy storage system 30. For example, in some embodiments, battery pack controller 34 may include processing circuitry and one or more memory devices similar to those disclosed above for vehicle infotainment circuitry 26.

I/O circuitry 36 may be coupled to battery pack controller 34 and battery pack 32 for distributing incoming data to the battery pack controller 34 and incoming power to battery pack 32. To that end, I/O circuitry 36 may include processing circuitry and one or more memory devices similar to those disclosed above for vehicle infotainment circuitry, as well as one or more circuit components, such as, but not limited to transformers, capacitors, resistors, etc. Some of these circuit components may be power electronic components, such as IGBT, power MOSFET, etc.

In some embodiments, I/O circuitry 36 may be demodulation circuitry configured to receive a signal having data modulated over power via vehicle charge port 16 and a powerline 38. Once the data and power are received from powerline 38, demodulation circuitry may demodulate the data from the power, distribute the data to the battery pack controller 34, and distribute the power to battery pack 32. To that end, in some embodiments, I/O circuitry 36 includes demodulation circuitry that may include one or more circuit components, such as, but not limited to transformers, capacitors, resistors, etc. Some of these circuit components may be power electronic components, such as IGBT, power MOSFET, etc.

Charge station 14 may be located proximate to or remote from vehicle charge port 16, and is coupled to vehicle charge port 16 via powerline 38. Charge station 14 may include a charging connector 40 configured to couple to vehicle charge port 16 to enable the transfer of power and/or data to vehicle 12. Charging connector 40 may include any suitable number and type of circuit components, such as transformers, rectifiers, capacitors, etc., capable of transferring a data signal and/or a power signal over powerline 38.

In some embodiments, charging connector 40 may include modulation circuitry configured to modulate data over power and transmit the modulated power signal to powerline 38 for further transmission to vehicle 12. In such embodiments, charging connector may include modulation circuitry including any suitable number and type of circuit components, such as transformers, rectifiers, capacitors, etc., capable of modulating data signal on power signal for the high bandwidth data transmission over powerline 38. Modulation circuitry may include signal processing circuitry such as digital-to-analog converter (DAC) and analog-to-digital converter (ADC).

Charge station 14 may also include charge station controller 42 coupled to charging connector 40 and configured to transfer data to charging connector 40. Charge station controller 42 may include processing circuitry and one or more memory devices similar to those disclosed for vehicle infotainment circuitry 26. In a further embodiment, charge station controller 42 may include one or more user interfaces similar to user interface(s) 24 in vehicle infotainment system 22 and may receive user input and generate output in response to the user input.

Charge station 14 may also include charge circuitry 44. Charge circuitry 44 may be configured to receive primary power, for example, from a power grid or other suitable source, and to convert the primary power into a charging power suitable for charging battery pack 32. Because primary power is usually in the form of AC power but vehicle 12 typically stores and uses DC power, charge circuitry 44 may include an AC to DC converter 46 to convert AC power to DC power.

Charge station 14 may be coupled to network connection 18 over a high bandwidth Ethernet connection 48. High bandwidth Ethernet connection 48 may be a wired Internet connection or a wireless Internet connection. Network connection 18 may provide charge station controller 42 with access to cloud data stored, for example, in cloud database 19. In this way, cloud data either stored in cloud database 19 or another cloud location, may be transferred to and/or from vehicle 12 via charge station controller 42, powerline 38, and vehicle charge port 16. As referred herein, cloud database 19 can be any data storage system on a remote server.

Network connection 18 may be any type of wired or wireless connection providing access to remotely stored cloud data in cloud database 19. For example, network connection 18 may be a virtual private network connection enabling access to the user's personal data (e.g., purchased movies, television shows, etc.) stored by a third party organization on behalf of the user. In other embodiments, network connection 18 can be the Internet, a cellular network, a Wi-Fi network, etc. For a further example, network connection 18 may provide access to a third party content database such as Netflix, Hulu, Amazon Prime, etc.

Cloud data stored in cloud database 19 may be any type of data that may be delivered to the vehicle 12. For example, cloud data may be rich content, such as movies, television shows, audio recordings, etc. Cloud data may be stored by any available cloud computing service to which the user has access or subscribes. Further, in some embodiments, cloud data may be data previously stored by the user in a personal cloud computing account. In other embodiments, cloud data may be vehicle system updates or data logs, as discussed in more detail below.

Cloud database 19 may be any database running on a cloud computing platform. For example, cloud database 19 may be a user-run or provider-run database. Cloud database 19 may be populated with data specific to one or more users of vehicle 12, operation of vehicle 12, use of vehicle infotainment system 22, etc., as discussed in more detail below.

In some embodiments, vehicle 12 and/or a user may be configured to send and receive data wirelessly. For example, vehicle 12 may be configured to receive cloud data and/or populate cloud database 19 through a wireless connection 21. For example, vehicle 12 may include a cell modem capable of receiving data wirelessly.

Further, the user may utilize a mobile device 50 (e.g., a mobile phone, tablet, personal laptop computer, etc.) to wirelessly send and/or receive data via a wireless connection 52. For example, in some embodiments, mobile device 50 may wirelessly receive user selected content from vehicle infotainment circuitry 26, charge station 14, cloud database 19, or any other suitable storage location of the selected content. For further example, mobile device 50 may send data corresponding to one or more user selections provided via an interface on mobile device 50.

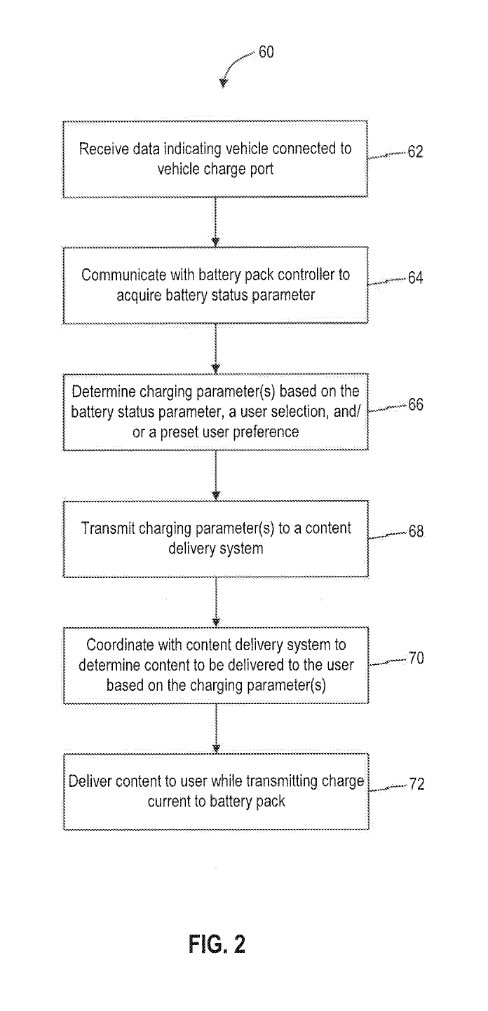

FIG. 2 is a flowchart illustrating an exemplary process 60 for determining content to be delivered to a user, in accordance with an aspect of the present disclosure. The process 60 may be implemented by any suitable controller(s) in the vehicle charging system 10, such as charge station controller 42. The process 60 includes receiving data indicating that vehicle 12 has been coupled to vehicle charge port 16 (step 62). For example, upon connection of vehicle 12 to vehicle charge point 16, a signal may be sent to charge station controller 42 to indicate that a connection has been formed.

Once charge station controller 42 is notified that vehicle 12 is connected to vehicle charge port 16, process 60 includes communicating with battery pack controller 34 to acquire at least one battery status parameter (step 64). For example, charge station controller 42 may send a signal via charging connector 40, powerline 38, vehicle charge port 16, and I/O circuitry 36, or may send a wireless signal, requesting one or more battery status parameters. The battery status parameters may be any parameter indicating a feature of battery pack 32, such as a state of charge (SOC), identification, model number, serial number, etc.

Once the one or more battery status parameters have been received, process 60 further includes determining one or more charging parameters based on the received battery status parameter(s), a user selection, and/or a preset user preference (step 66). The charging parameters may be any parameter that partially or fully guides the charging of battery pack 32 in the given session. For example, the charging parameters may include a time duration to be used to charge battery pack 32, a charging current or charging power used to charge battery pack 32, a total energy to be used to charge battery pack 32, a total cost that the user is willing to pay for the charging of battery pack 32, and so forth.

In some embodiments, the charging parameters may be derived from the battery status parameter. For example, the battery status parameter may indicate the SOC of the battery, and the charging current may be determined to be an amount suitable to restore full (or any predetermined level of) charge to battery pack 32 in a given amount of time.

In other embodiments, the charging parameters may be received directly from the user, for example, via user interface 24 and/or mobile device 50. In still further embodiments, charge station controller 42 may access stored preset user preferences and/or a user profile stored, for example, in cloud database 19.

Process 60 also includes transferring the charging parameter(s) to a content delivery system, such as vehicle infotainment system 22 and/or mobile device 50 via a wired or wireless connection (step 68). Charge station controller 42 may then coordinate with the selected content delivery system to determine content to be delivered to the user based on the determined charging parameter(s) (step 70). For example, charge station controller 42 and/or the content delivery system (e.g., mobile device 50, vehicle infotainment system 22, etc.) may select content that has a time duration similar to the time duration used to charge battery pack 32 of vehicle 12. The content delivery system may also compose a set of content that, in combination, has a time duration similar to the time duration used to charge battery pack 32 of vehicle 12. Alternatively or additionally, the content delivery system may also have preloaded content and can automatically select one or more programs with a time duration similar to the time duration used to complete a charge of the battery pack 32.

Process 60 further includes delivering the determined content to the user while transmitting charge current to battery pack 32 to recharge battery pack 32 (step 72). The selected content may be delivered to the user through a hand-held device (e.g., mobile device 50) or an on-board system (e.g., vehicle infotainment system 22). Further, in some embodiments, the mobile device 50 and/or user interface 24 may be configured to be selectively attached to and detached from vehicle infotainment system 22. For example, in one embodiment, mobile device 50 may form user interface 24 and may be inserted and removed from a socket to enable the user to consume the content in vehicle 12 or remote from vehicle 12. In one embodiment, the user interface 24 can display and update the running time of the content (e.g., remaining minutes) and the time required to complete charging the battery in the vehicle.

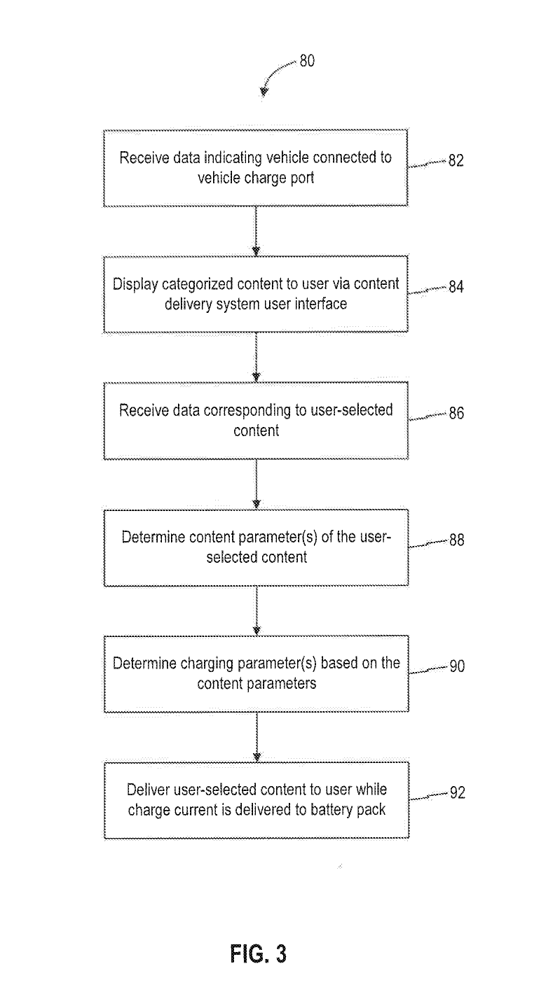

FIG. 3 is a flowchart illustrating an exemplary process 80 for determining the charging parameter(s), in accordance with an aspect of the present disclosure. Process 80 may be implemented by any suitable controller(s) in vehicle charging system 10, such as vehicle infotainment circuitry 26. Process 80 includes receiving data indicating that vehicle 12 has been coupled to vehicle charge port 16 (step 82). For example, upon connection of vehicle 12 to vehicle charge point 16, a signal may be sent to vehicle infotainment circuitry 26 to indicate that a connection has been formed.

Process 80 further includes displaying categorized content to the user via a content delivery system user interface (step 84). For example, the categorized content may be displayed on user interface 24, mobile device 50, and/or a user interface associated with charge station 14. In some embodiments, the presented content may be categorized based on, for example, length, genre, production year, leading star, etc.

Once the user selects one or more pieces of content from the categorized content, process 80 includes receiving data corresponding to the user-selected content (step 86) and determining one or more content parameters associated with the user-selected content (step 88). The content parameters may include underlying metadata of the selected content, for example, the length, the total cost, the unit cost (cost per second/minute), etc.

Process 80 also includes determining the charging parameter(s) for charging battery pack 32 based on the content parameter(s) (step 90). For example, if the content parameter is a length of time the content runs, the charging time may be set to equal the running time of the selected content, and the charging current may be set to obtain the maximum amount of charge in the run time, preferably without causing damage to the longevity of battery pack 32. The user-selected content may then be delivered to the user while the charge current is delivered to battery pack 32 (step 92).

In another embodiment, once the data is received at step 82 indicating that vehicle 12 is connected to vehicle charge port 16, a processor located, for example, in vehicle infotainment circuitry 26, may receive or determine an amount of time required to complete a charging operation for battery pack 32. For example, in some embodiments, a user may input the amount of time the user is willing to wait for charging to be complete. For a further example, in other embodiments, the processor may determine how long a charging operation will take to fully recharge battery pack 32.

The amount of time determined to be available or required for a given charging operation may then be used by infotainment circuitry 26 to determine the content displayed to the user, for example, at step 84. For instance, vehicle infotainment circuitry 26 may prompt the user to choose among multiple programs each with a length less than or equal to the available charging time, or may automatically provide content of the appropriate length to the user.

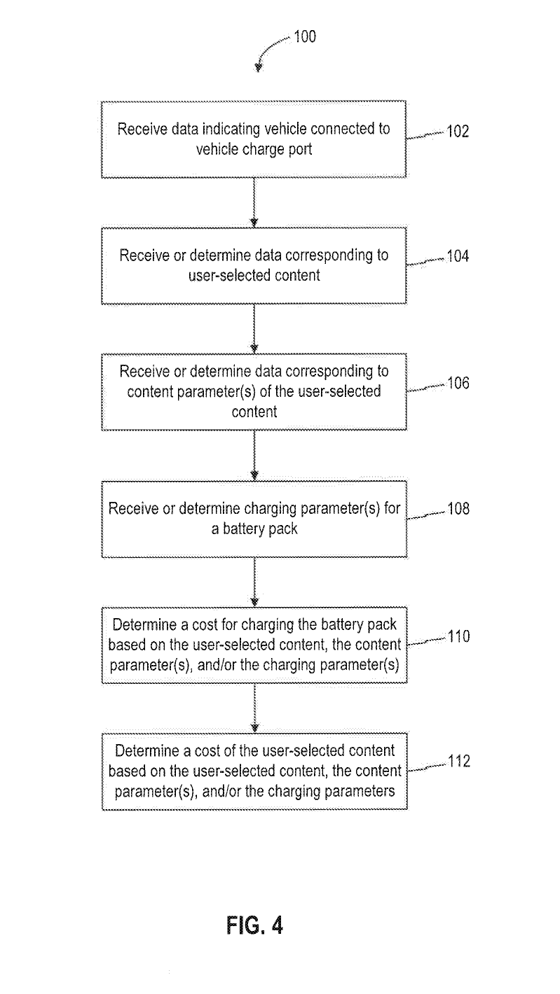

FIG. 4 is a flowchart illustrating an exemplary process 100 for determining a monetary cost for user-selected content and/or vehicle charging, in accordance with an aspect of the present disclosure. Process 100 may be implemented by any suitable controller(s) in the vehicle charging system 10 or a remotely located controller. Process 100 includes receiving data indicating that vehicle 12 has been coupled to vehicle charge port 16 (step 102). For example, upon connection of vehicle 12 to vehicle charge point 16, a signal may be sent to charge station controller 42 to indicate that a connection has been formed.

Process 100 further includes receiving or determining data corresponding to user-selected content (step 104). For example, the user may select content via, for example, user interface 24 or the user interface on the charge station, and data indicative of the user-selected content may be transferred from vehicle infotainment circuitry 26 to charge station controller 42. In other embodiments, the controller executing process 100 may determine the content to be delivered, for example, based on preset user preferences or a stored user profile.

Process 100 also includes receiving or determining data corresponding to one or more content parameter(s) of the user-selected content (step 106). The content parameter(s) may be determined as described above for step 88 in connection with FIG. 3, or may be received from another controller that extracted the content parameter(s) and transferred them to the controller executing process 100. Process 100 also includes receiving or determining the charging parameter(s) for battery pack 32 (step 108), for example, as described in detail above for step 90 in connection with FIG. 3.

The process 100 also includes determining a monetary cost for charging battery pack 32 based on the user-selected content, the content parameter(s), and/or the charging parameter(s) (step 110), and determining a monetary cost of the user-selected content based on the user-selected content, the content parameter(s), and/or the charging parameter(s) (step 112). That is, the cost of one or both of the battery pack charging and the content may be adjusted based on the content and/or one or more of the determined parameters.

For example, in some embodiments, if the user selects a high charging power or current, a short time duration, and/or a low amount of total charging energy to charge battery pack 32, the user-selected content may be charged at a higher rate because the user is willing to wait a short amount of time and will consume less content. On the other hand, if the user selects a lower charging power or current, a long charge duration, and/or a large amount of total charging energy to charge the battery, the selected content may be charged at a lower rate because the user is willing to spend more time to consume more content. In this way, in some embodiments, the user may be provided with a monetary incentive to remain connected to vehicle charge port 16 for a longer period of time. The foregoing feature may be advantageous because the more time the user spends connected to vehicle charge port 16, the more time the charge circuitry 44 has to transfer charging power to battery pack 32. A longer charge time available to charge a predetermined amount of energy requires a lower charge current or power and thus, the longevity of battery pack 32 may be increased, and demand on the charging infrastructure may be reduced.

In another embodiment, if a user selects content with a greater length, charge station controller 42 may set a lower cost for charging or a lower charging power or current because the user is willing to wait longer to charge the battery and consume more content. If, on the other hand, the user selects content with a shorter length, charge station controller 42 may set a greater cost for charging or a greater charging power or current because the user has less time and will consume less content.

In other embodiments, if the user selects both the charging parameter(s) and the content, charge station controller 42 may adjust the rate for the charging of battery pack 32 and the content, for example, based on a set of rules. For example, if the length of the content selected is greater than the time duration needed to charge battery pack 32 (determined based on the charging parameter(s)), charge station controller 42 may deliver only a portion of the content to the user at a higher rate. Charge station controller 42 or vehicle 12 may notify the user, through the user interface thereon, about the difference between the length of the selected content and the duration of the charge time, and may further prompt the user to make changes to the selected content and/or the charging parameters. As a result, charge station controller 42 may provide incentives for the user to select a greater charging duration, a lower charging power or time, or a higher total energy to charge battery pack 32.

In other embodiments, each charge rate selection made by a user may be stored by the infotainment system 22 and/or a cloud service that is associated with a user. In this way, the charge rates used to charge battery pack 32 for vehicle 12 may be monitored over the life of battery pack 32 and/or limited such that the number of times battery pack 32 is charged at a rate above a given threshold is limited. For example, in some embodiments, battery pack 32 may be limited to a certain number (e.g., 3) of charging operations in which a charge rate threshold is exceeded. When a user approaches or exceeds the predetermined number of high charge rate sessions, the user may be incentivized to select a lower charge rate for future sessions, for example, by reducing the price for subsequent low charge rate sessions or increasing the price for subsequent high charge rate sessions.

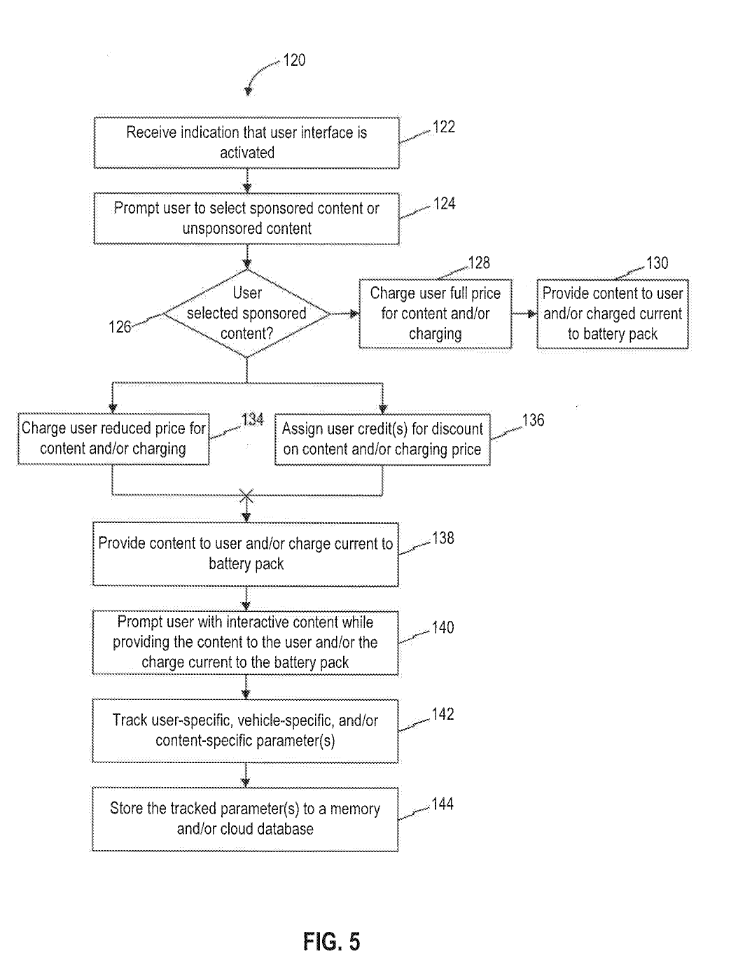

FIG. 5 is a flowchart illustrating an exemplary process 120 for determining a monetary cost for user-selected content and/or vehicle charging based on a sponsored content selection, in accordance with an aspect of the present disclosure. Process 120 may be implemented by any suitable controller(s) in the vehicle charging system 10 or a remotely located controller. Process 120 includes receiving data indicating that a user interface is activated (step 122). For example, user interface(s) 24 and/or an interface on mobile device 50 may be activated by, for example, a user powering on the interface, logging into a system via the interface, etc.

The process 120 then includes prompting the user to select sponsored content or unsponsored content (step 124). Sponsored content may be content for which a provider agrees to pay money in exchange for the right to provide the content to a user, thus subsidizing the cost of battery charging and/or user-selected content for the user. The sponsored content may include standalone sponsored content, such as product infomercials, or integrated content, such as commercials interspersed in regular entertainment content.

Process 120 queries whether the user selected the sponsored content (step 126). If the sponsored content was not selected, the user is charged full price for the selected content and/or the charging power to charge battery pack 32 (step 128). The content is then provided to the user and/or the charging power is delivery to battery pack 32 (step 130).

However, if the user selected the sponsored content, the user may be charged a reduced price for the content and/or the charging power (step 132). That is, the user may receive a discount if the sponsored content is chosen because the charging and/or content price was subsidized by the provider of the sponsored content. Further, in some embodiments, the user selection of the sponsored content may occur before the user is at the point of content selection in a given charging session. For example, some third party companies may offer sponsored content subscriptions to which the user has subscribed, thus entitling the user to receive subsidized charging when the content is consumed.

Additionally, in some embodiments, a user selection of the sponsored content may result in assignment of credit(s) to the user or to the user's account for a discount on content and/or charging power (step 136). That is, in some instances, the user may select and/or consume the sponsored content before a charging session is initiated, and the assigned credit may be accumulated to later discount or pay for a future charging session. In other instances, the user selection of sponsored content may result in a greater number of assigned credits than necessary to complete the given charging session, and the excessive balance may be saved for a future charging session.

That is, in some embodiments, in step 136, the sponsored content may be offered and consumed at both locations and times that are separate from both the vehicle and/or charging system use. To effectuate a later application of the assigned credit, the user may first associate a digital account with both a sponsor and the user's vehicle. The user may then consume sponsored content and earn credits. These credits may then be used during a later charging session to obtain a discount on the user's vehicle charging cost.

Once the price reduction and/or credits are applied to the user's account, the content is provided to the user and/or the charge current is provided to battery pack 32 (step 138). In some embodiments, while the content is being provided to the user and/or the charge current is being provided to battery pack 32, the user may be prompted with interactive content (step 140). The interactive content may be used by the sponsor of the sponsored content to ensure their content is being actively consumed, and also to incentivize a user to actively consume the sponsored content. For example, the interactive content may be provided in the form of user interactive quiz games. The quiz games may be configured to utilize, for example, user interface(s) 24 of vehicle infotainment system 22 to display questions about the sponsored content and/or receive the user's responses. In some embodiments, bonus credits may be assigned if the user provides adequate responses to the interactive quiz games.

Process 120 may also include tracking user-specific, vehicle-specific, and/or content-specific parameter(s) (step 142). The tracked parameters may then be stored to a memory associated with the controller executing process 120 and/or to cloud database 19 (step 144). For example, in some embodiments, a user's data may be tracked for the purpose of determining when a predetermined threshold is exceeded, thus qualifying the user for a further discount. For example, the predetermined threshold may be set such that users in a top percentage of usage (e.g., top 10%) compared to all other subscribers are given an additional discount.

For instance, a user subscribing to a content streaming service (e.g., Netflix, Hulu, Amazon Prime, etc. may be offered a discount on his charging cost at designated charging locations. A premium membership with the content streaming service may correspond to a larger discount on charging. Similarly, the network of designated charging stations may track the total amount of money a user spends on charging his vehicle at the designated charging stations. This may include the charging port or network identifying the user by his vehicle's vehicle identification number (VIN), Internet Protocol (IP) address, or another assigned unique identification code. If the user's charging spending reaches a predetermined threshold amount, the user may be offered free or discounted content, or a limited free membership to the content streaming service for a trial period. In other embodiments, if the user's per month average charging cost reaches a certain level over a given time period (e.g., over a period of a few months), the user may be offered a free or discounted membership to the content streaming service.

In still further embodiments, one or more charge stations, such as charge station 14, may track the content that has been delivered to vehicle 12. For example, the charge station 14 may store the vehicle ID and a content ID in cloud database 19, and cloud database 19 may be accessible by all charging stations in the given network. If the charging time in a given charging session is shorter than the running time of the content (e.g., a movie) a user is watching, cloud database 19 may also store information indicating the stopping point of the content so that when the user goes to charge vehicle 12 at a later time, charge station controller 42 can stream the same content to vehicle 12 from the stopping point.

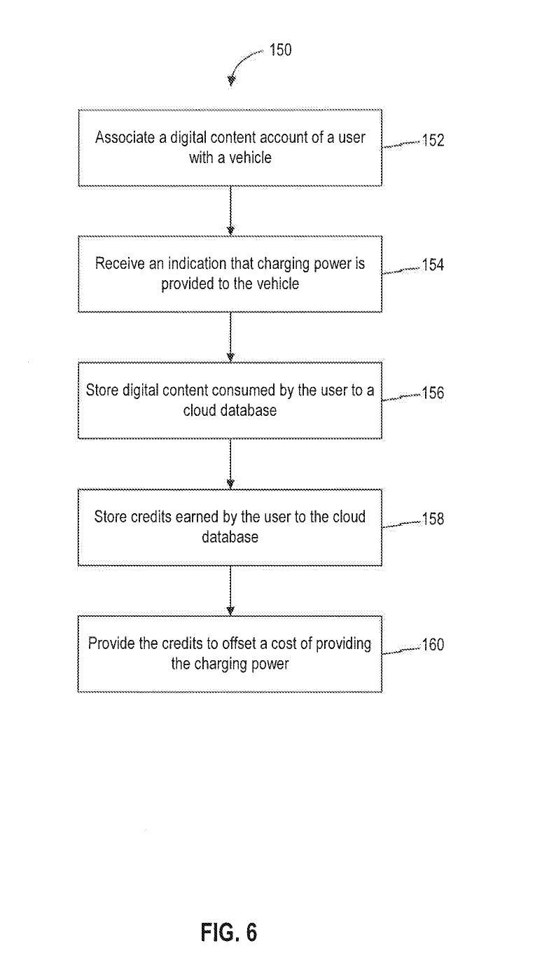

FIG. 6 is a flowchart illustrating an exemplary process 150 for storing digital content in cloud database 19, in accordance with an aspect of the present disclosure. Process 150 may be implemented by any suitable controller(s), such as charge station controller 42. Process 150 includes associating a digital content account of a user with vehicle 12 (step 152). The user's digital account may be a subscription to a sponsor's service, an account provided by the manufacturer of vehicle 12, an account provided by a third party, or any other user-specific digital account.

Process 150 further includes receiving an indication that charging power is provided to vehicle 12 (step 154). Process 150 also includes storing digital content consumed by the user to cloud database 19 (step 156). For example, cloud database 19 may include a list of all content consumed across all charging sessions by a given user. This consumed content list may be used, for example, when determining which content to present to a user in a future charging session to ensure new content is available each time the user charges vehicle 12.

Process 150 further includes storing credits earned by the user to cloud database 19 (step 158). For example, the credits earned at step 136 of FIG. 5 for consumption of sponsored content may be stored to cloud database 19 and associated with the user's digital content account. The stored credits may then be provided from the cloud database 19 during a charging session to offset a cost of providing the charging power during that session (step 160). In this way, the cloud database 19 may be updated during charging sessions to track the user's activity and keep track of earned and used credits.

The example embodiments disclosed herein include computer-implemented methods, non-transitory computer-readable mediums, and systems. The computer-implemented methods may be executed, for example, by at least one processor that executes instructions stored in a non-transitory computer-readable storage medium. Similarly, systems consistent with the present disclosure may include at least one processor and memory (e.g., a non-transitory computer-readable storage medium). As used herein, a non-transitory computer-readable storage medium may include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. A computer-readable storage medium may store instructions for execution by at least one processor, including instructions for causing the processor to perform steps or stages consistent with the embodiments described herein. Additionally, one or more computer-readable storage mediums may be used to implement a computer-implemented method. The term “computer-readable storage medium” should be understood to include tangible items and exclude carrier waves and transient signals.

It will be apparent to those skilled in the art that various modifications and variations can be made to the disclosed systems. Other embodiments will be apparent to those skilled in the art from consideration of the specification and practice of the disclosed systems and methods. It is intended that the specification and examples be considered as exemplary only, with a true scope being indicated by the following claims and their equivalents.

1. (canceled)

2. (canceled)

3. (canceled)

4. (canceled)

5. (canceled)

6. (canceled)

7. (canceled)

8. (canceled)

9. (canceled)

10. A vehicle charging method, comprising:
displaying categorized content including sponsored content to a user via a user interface of a content delivery system;
receiving data corresponding to a user selection of sponsored content; and
determining a discounted cost for providing a charging power to at least one battery of a vehicle that is at least partially electrically powered, based on the user selection of the sponsored content.

11. The vehicle charging method of claim 10, further comprising determining an amount of earned credits associated with the selected sponsored content, wherein the discounted cost for providing the charging power is determined based on the amount of earned credits.

12. The vehicle charging method of claim 10, further comprising prompting the user to interact with interactive content provided to the user while the user is consuming the sponsored content; and receiving a user input corresponding to the user's interaction with the interactive content.

13. The vehicle charging method of claim 12, wherein the interactive content comprises a quiz game prompting the user to answer questions about the sponsored content.

14. The vehicle charging method of claim 10, further comprising receiving data indicative of a content subscription status of the user.

15. The vehicle charging method of claim 14, further comprising lowering the discounted cost for providing the charging power when the data indicates the user is subscribed to a content delivery service.

16. The vehicle charging method of claim 14, further comprising determining if a spending level of the user exceeds a predetermined threshold when the data indicates the user is subscribed to a content delivery service.

17. The vehicle charging method of claim 16, further comprising providing the user selection of the sponsored content for free to the user when the spending level of the user exceeds the predetermined threshold.

18. A method for managing a vehicle user account using a cloud database, the method comprising:
associating a digital content account of a user with a vehicle that is at least partially electrically powered;
receiving an indication that charging power is provided to the vehicle;
storing digital content consumed by the user to the cloud database;
storing credits earned by the user associated with the digital content account to the cloud database; and
providing the credits to offset a cost of providing the charging power.

19. The method of claim 18, herein the digital content includes sponsored content consumed by the user, and where the credits are awarded for consuming the sponsored content.

20. The method of claim 18, further comprising storing a topping point corresponding to a time point when the digital content was stopped associated with the completion of a vehicle charging session.

21. (canceled)

22. (canceled)

23. (canceled)

24. A vehicle charging system, comprising:
a vehicle infotainment system for an at least partially electrically powered vehicle comprising a user interface and being configured to display categorized content to a user, receive a user input corresponding to user-selected content, and determine at least one content parameter associated with the user-selected content; and
an energy storage system comprising a battery pack and a controller configured to receive the at least one content parameter from the vehicle infotainment system and to determine one or more charging parameters for charging the battery pack based on the at least one content parameter.

25. The vehicle charging system of claim 24, wherein the vehicle infotainment system is configured to deliver the user-selected content to the user via the user interface while the battery pack is charged according to the one or more charging parameters.

26. (canceled)
